(19) United States
(12) Patent Application Publication
(10) Pub. No.: US 2014/0215780 A1
(43) Pub. Date: Aug. 7, 2014

(54) METHOD AND DEVICE FOR PERFORATING A NON-WOVEN FABRIC BY MEANS OF HYDRODYNAMIC NEEDLING

(71) Applicants: Florian Seils, Rodgau (DE); Ullrich Münstermann, Egelsbach (DE)

(72) Inventors: Florian Seils, Rodgau (DE); Ullrich Münstermann, Egelsbach (DE)

(21) Appl. No.: 14/346,084

(22) PCT Filed: Sep. 11, 2012
(86) PCT No.: PCT/EP2012/067690

§ 371 Date: Mar. 20, 2014

(30) Foreign Application Priority Data
Sep. 20, 2011 (DE) 10 2011 113 672.3

(51) Int. Cl. B26F 1/26; D04H 1/495

(52) U.S. Cl. CPC B26F 1/26; D04H 1/495
USPC 28/167

(57) ABSTRACT

A device (1,3) for perforating a non-woven fabric (22, 26, 28, 34) by means of hydrodynamic needling is proposed, having a first carrier element (12, 40) with a carrier surface (14, 42), wherein the first carrier surface (14, 42) has first elevations and first perforations (4, 4′, 4″) as drainage openings and wherein the non-woven fabric (22, 26, 28, 34) for processing can be placed on the first carrier surface (14, 42) having at least a first nozzle bar (24, 24′, 36, 36′) comprising openings, wherein fibres of the non-woven fabric (22, 26, 28, 34) arranged on the first carrier surface (14, 42) which are arranged on the first elevations of the first carrier surface (14, 42) can be flushed down from the elevations by means of liquid (3) emerging under high pressure from the openings of the first nozzle bar (24, 24′, 36, 36′), such that perforations (4, 4′, 4″) are created in the non-woven fabric (22, 26, 28, 34), and wherein a second carrier element (14, 42) is provided, having second elevations and second perforations (4, 4′, 4″) as drainage openings, wherein the elevations of the second carrier element (12, 40) are spaced in relation to each other and the non-woven fabric (22, 26, 28, 34) provided with the perforations (4, 4′, 4″) can be positioned on the second carrier element (12, 40) such that the elevations of the second carrier element (12, 40) protrude into the perforations (4, 4′, 4″) of the non-woven fabric (22, 26, 28, 34) arranged on the second carrier element (12, 40), wherein at least a second nozzle bar (24, 24′, 36, 36′) is provided by means of which the non-woven fabric (22, 26, 28, 34) is subjected to a liquid (30) emerging under high pressure from the openings of the second nozzle bar (24, 24′, 36, 36′).

The invention relates to a method for producing a carrier element for a device for perforating a non-woven fabric by means of hydrodynamic needling according to claim 1, a device for perforating a non-woven fabric by means of hydrodynamic needling according to the precharacterizing part of claims 7 and 12, and a method perforating a non-woven fabric by means of hydrodynamic needling according to claim 25.

Currently known devices for perforating a non-woven fabric by means of hydrodynamic needling comprise at least one carrier element having a first carrier surface. The first carrier surface comprises first elevations and first perforations as drainage openings. The non-woven fabric for processing can be placed on the carrier surface. By means of a liquid issuing from the openings of a nozzle bar, fibers of the non-woven fabric arranged on the carrier surface will be washed off from the elevations, thus generating perforations. In the currently known devices and methods, however, there exists the disadvantage that particularly heavy non-woven fabrics having a weight per unit area above 70 g/m² can be perforated only with difficulties.

Heavy non-woven fabrics are frequently used as geotextiles. These often consist of a hydrophobic material, particularly of staple fibers or endless filaments of PP or PET. However, in order to use the heavy non-woven fabrics as geotextiles, these are partially additionally provided with a hydrophilic finish for better drainage of surface water. According to the present invention, it is provided that, instead of the hydrophilic finish, drainage openings are to be formed in such heavy non-woven fabrics, wherein said drainage openings are to be formed by hydrodynamic needling. This has the advantage said approach is simpler and less expensive than the application with a hydrophilic finish.

Thus, it is an object of the present invention to provide a device and a method for perforating a non-woven fabric and to provide a method for producing a carrier element for a device for perforating a non-woven fabric, which device and which method make it possible to perforate heavy non-woven fabrics having a weight per unit area of 70 g/m².

The above object is achieved by the features defined in claims 1, 7, 12 and 25.

The invention provides in an advantageous manner that, in a method for producing a carrier element for a device for perforating a non-woven fabric by means of hydrodynamic needling, the following steps are performed:
producing a sheet-metal element,
forming perforations in the sheet-metal element,
forming elevations in the sheet-metal element by means of deep drawing, and
coating the sheet-metal element provided with said perforations and elevations.

The invention has the advantage that the elevations will be formed in the sheet-metal element by deep drawing. Thereby, the sheet-metal element can be provided with elevations which have such a height that, with the aid of these perforations, perforations can be formed also in a heavy non-woven fabric. Further, the coating has the advantage that the carrier element provided with the coating has a longer durability.

According to the present state of the art, the carrier elements are in most cases produced from stainless sheet metal. This, however, has the disadvantage that the sheet metal has a relatively high toughness and the elevations can have only special shapes and dimensions. Further, it is not possible to form the elevations in a piece of stainless sheet metal by means of deep drawing. In such a piece of stainless sheet metal, the height of the elevations can only be half as large as the diameter of the elevations.

In the present invention, however, there is the advantage that the stainless sheet metal will first be deep-drawn and, thus, elevations of any desired shape and height can be produced. The carrier element obtains its durability by the coating.

The elevations which are formed in the sheet metal element can respectively have such a size and shape that, in hydrodynamic needling, a heavy non-woven fabric having a weight per unit area of at least 70 g/m² to 260 g/m² can be perforated by the elevations such that perforations are generated in the non-woven fabric that have an opening width of at least 4 mm.

The elevations of the carrier element can have a base with a polygonal, circular, semicircular or oval cross-sectional shape. Also the perforations can have a polygonal, circular, semicircular or oval cross-sectional shape in the plane of the non-woven fabric. The shape of the perforations in the non-woven fabric is dependent on the shape of the elevations in the carrier element. The shape of the perforations can additionally be dependent e.g. on whether the non-woven fabric, when taken off the carrier element, will rotate e.g. in transport direction. In this case, oval perforations will be generated in the non-woven fabric, although the elevations of the carrier element have circular cross-sectional shapes.

The opening width is the largest width of the respective opening. In case of circular perforations, the opening width is the diameter. Oval—i.e. preferably elliptic perforations—have a respective largest and a respective smallest diameter. The opening width is the largest diameter of the oval. The smallest width of the oval perforation is the smallest diameter.

The elevations which are formed in the sheet metal element can respectively have such a size and shape that, in hydrodynamic needling, a heavy non-woven fabric having a weight per unit area of at least 70 g/m² to 260 g/m² can be perforated by the elevations such that perforations are generated in the non-woven fabric that have an opening width of at least 3 mm.

The sheet-metal element can be made of a material having such a toughness that the elevations can be formed in the sheet-metal element by means of deep drawing, said material preferably being a metal.

Since the sheet-metal element has a toughness adapted to allow the elevations to be formed in the sheet-metal element by deep drawing, the elevations can be formed in the carrier element by means of a simple and inexpensive measure.

The sheet-metal element can be coated with a material having a higher toughness than the material of the sheet-metal element. This has the advantage that the carrier element will have a considerably longer durability.

The sheet-metal element can be coated with a metal, preferably nickel.

The sheet-metal element preferably does not consist of nickel. Nickel has a too high toughness so that the elevations cannot be formed in the sheet-metal element by deep-drawing if the sheet-metal element consists of nickel.

The invention advantageously provides that, in a device for perforating a non-woven fabric by means of hydrodynamic needling, a second carrier element is provided, which comprises a second carrier surface having second elevations and second perforations as drainage openings, wherein, on the one hand, the elevations of the second carrier element have such a distance each other and, on the other hand, the non-woven fabric provided with the perforations can be positioned on the second carrier element in such a manner that the elevations of the second carrier element protrude into the perforations of the non-woven fabric arranged on the second carrier element, wherein at least one second nozzle bar is provided and wherein the non-woven fabric can be subjected to a liquid emerging under high pressure from the openings of the second nozzle bar.

The device has the advantage that particularly a heavy non-woven fabric having a weight per unit area of at least 70 g/m², preferably at least 100 g/m², can be perforated in a very good manner. Due to the fact that, in a second step, the non-woven fabric will be perforated again on a second carrier element, while the elevations of the second carrier element extend into the already existing perforations, it is possible to generate very well-formed and precisely defined perforations in the non-woven fabric. In this manner, also particularly heavy non-woven fabrics of up to 260 g/m² can be perforated.

The non-woven fabric on the first carrier element can be placed on the first carrier element by a non-woven-fabric top side, and the non-woven fabric can be subjected, on a non-woven-fabric bottom side, to the liquid emerging from the openings of the first nozzle bar. The non-woven fabric can be placed on the second carrier element by the non-woven-fabric bottom side, and the non-woven fabric can be subjected, on the non-woven-fabric top side, to the liquid emerging from the openings of the second nozzle bar.

This has the advantage that the perforations in the non-woven fabric will be formed in a particularly good manner since the non-woven fabric will be hydrodynamically needled from both sides. Further, also the toughness of the non-woven fabric is increased by the double treatment with the liquid.

The shape and the size of the respective elevations of the second carrier element can be selected in such a manner that the elevations of the second carrier element can project into the perforations of the non-woven fabric which is to be placed on the second carrier element. The elevations preferably have a height of at least 3.5 mm. The elevations of the second carrier element must have a certain height so that, when the non-woven fabric is being placed on the second carrier element, the elevations of the second carrier element can project into the already existing perforations of the non-woven fabric. In this manner, the non-woven fabric will be perforated once more again on the second carrier element at the same sites, and the perforations can be formed more distinctly. If the elevations of the second carrier element would not extend exactly into the already existing perforations of the non-woven fabric, further perforations would be generated in the non-woven fabric, and the already existing perforations would not be clearly defined perforations.

The sizes and the shape of the elevations of the first and the second carrier element can be selected in such a manner that, in hydrodynamic needling, heavy non-woven fabrics having a weight per unit area of at least 70 g/m² can be perforated by the elevations such that perforations are generated in the non-woven fabric that have an opening width of at least 4 mm, preferably at least 5 mm. The first and the second carrier element can each consist of a base element and a coating, and the elevations in the respective sheet-metal element can be formed by deep drawing. The respective sheet-metal element can be coated by said coating layer.

In a device for perforating a non-woven fabric by means of hydrodynamic needling, it can be advantageously provided that the sizes and the shape of the elevations of the first carrier element are selected in such a manner that, in hydrodynamic needling, a heavy non-woven fabric having a weight per unit area of at least 70 g/m² can be perforated by the elevations such that perforations are generated in the non-woven fabric that have an opening width of at least 4 mm, preferably at least 5 mm, wherein the first carrier element consists of a sheet-metal element and a coating, and the elevations can be formed in the sheet-metal element by deep drawing and are coated by said coating.

The sizes and the shape of the elevations of the first carrier element can be selected in such a manner that, in hydrodynamic needling, heavy non-woven fabrics having a weight per unit area of at least 70 g/m² can be perforated by the elevations such that perforations are generated in the non-woven fabric that have a smallest width of at least 3 mm. In case of an oval, preferably elliptic perforation, the smallest width of the perforation is the smallest diameter.

The respective sheet-metal element can consist of a material which has such a toughness that the elevations can be produced by deep drawing.

The respective coating can consist of a material having a higher toughness than the material of the respective sheet-metal element.

The respective coating can consist of a metal, preferably nickel.

The elevations of the first and/or the second carrier element can have a diameter of at least 4 mm, preferably 5 mm, and the shapes of the elevations can be selected in such a manner that a heavy non-woven fabric having a weight per unit area of at least 70 g/m², preferably a weight per unit area in the range from 100 g/m² to 260 g/m², can be perforated.

The height of the elevations of the first and/or second carrier element can correspond to at least half the diameter of the elevations of the first and/or second carrier element.

The elevation of the first and/or second carrier element can have a diameter in the range from 5 to 13 mm. The elevations of the first and/or second carrier element can have the shape of spikes.

The elevations of the first and/or second carrier element can have a conically tapering or a frustoconical shape.

The elevations of the first and/or second carrier element can have a base with a circular, semicircular, oval or polygonal cross-sectional shape.

The first and/or second carrier element can respectively be a drum shell of a drum, and the respective drum surface can be the surface of the respective drum shell. The first and/or second carrier element can be a continuously surrounding band. The tape can be a flexible metal band.

According to the present invention, in a method for perforating a heavy non-woven fabric, the following method steps are advantageously provided:
applying a non-woven fabric having a weight per unit area of at least 70 g/m² onto a first carrier surface of a first carrier element, the first carrier surface having first elevations and first perforations as drainage openings,
forming perforations in the non-woven fabric by a first treatment of the non-woven fabric on the first carrier surface by means of highly pressurized liquid, wherein at least a part of the fibers of the non-woven fabric which during the liquid treatment are placed on the elevations, are washed down from the elevations by means of said liquid so that perforations are generated in the non-woven fabric,
applying the non-woven fabric provided with said perforations onto a second carrier surface of a second carrier element, the second carrier surface having second elevations and second perforations as drainage openings, wherein, on the one hand, the second elevations have such a distance from each other and, on the other hand, the non-woven fabric provided with the perforations is positioned on the second carrier surface in such a manner that the elevations protrude into the perforations,
second treatment of the non-woven fabric on the second carrier surface by means of a highly pressurized liquid.

This method has the advantage that also heavy non-woven fabrics can be perforated in a good manner, wherein the perforations are clearly defined.

In the second treatment with liquid, a part of the fibers of the non-woven fabric which in the first treatment with liquid have not been washed off from the first elevations, can be washed from the second elevations during the second treatment with liquid. This has the advantage of allowing for particularly clearly defined perforations in a heavy non-woven fabric.

The non-woven fabric arranged by a non-woven-fabric top side on the first carrier element can be subjected to liquid from a non-woven-fabric bottom side, and the non-woven fabric provided with perforations and arranged on the second carrier element can be subjected to liquid from a non-woven-fabric top side. On the second carrier element, the non-woven fabric is arranged on the carrier element by the non-woven-fabric bottom side. This has the advantage that, in the second step, the non-woven fabric will be subjected to liquid on the non-woven-fabric top side, with the result that the perforations are very clearly defined from the non-woven-fabric top side and that the perforations in the non-woven fabric are free of fibers. This has the advantage that the drainage of surface water, such as e.g. rain, can be improved.

It is possible to generate perforations having an opening width of at least 5 mm in the non-woven fabric, said perforations having an opening width of at least 4 mm and preferably 5 mm being generated in that the sizes and the shape of the elevations are selected to the effect that the fibers of the non-woven fabric which during the liquid treatment are placed on the elevations, are washed down from the elevations by means of said liquid.

Using the method of the present invention, a geotextile can be produced.

The non-woven fabric produced according to the present invention consists of staple fibers made of PP, PET, PA or other polymers, or of endless filaments (spunbond) made of perforations or PET or other polymers.

Embodiments of the inventions will be described in greater detail hereunder with reference to the drawings.

The following is schematically illustrated:

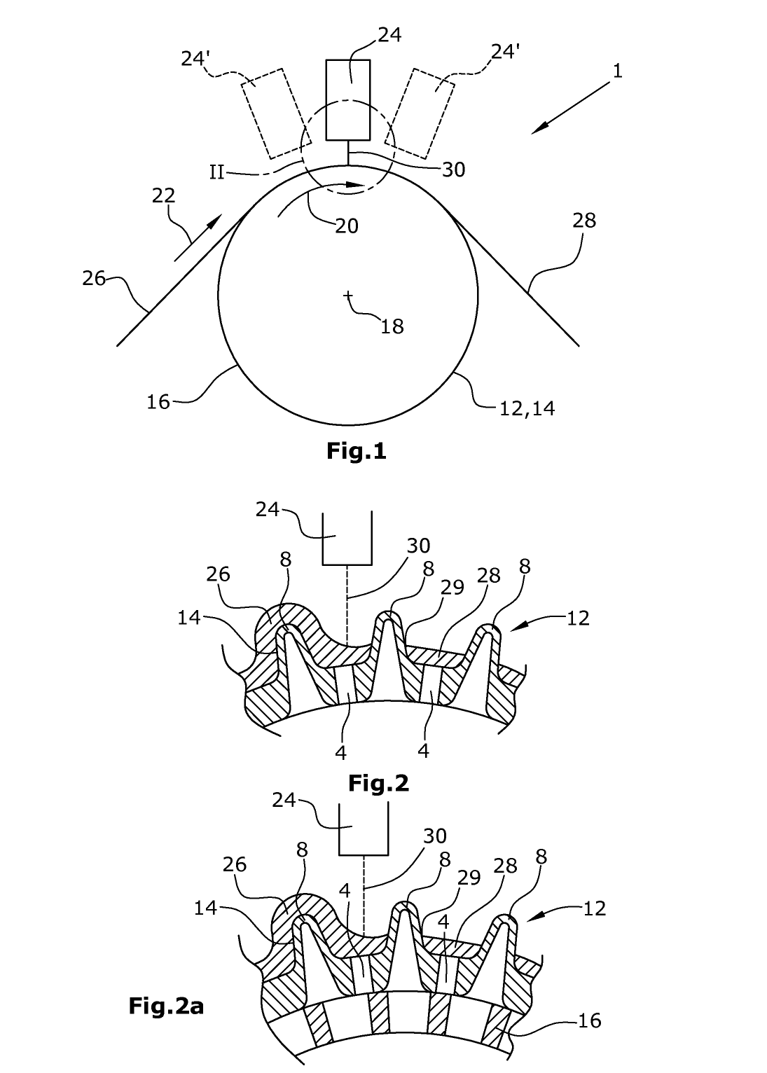

FIG. 1 a device for perforating a non-woven fabric by means of hydrodynamic needling,

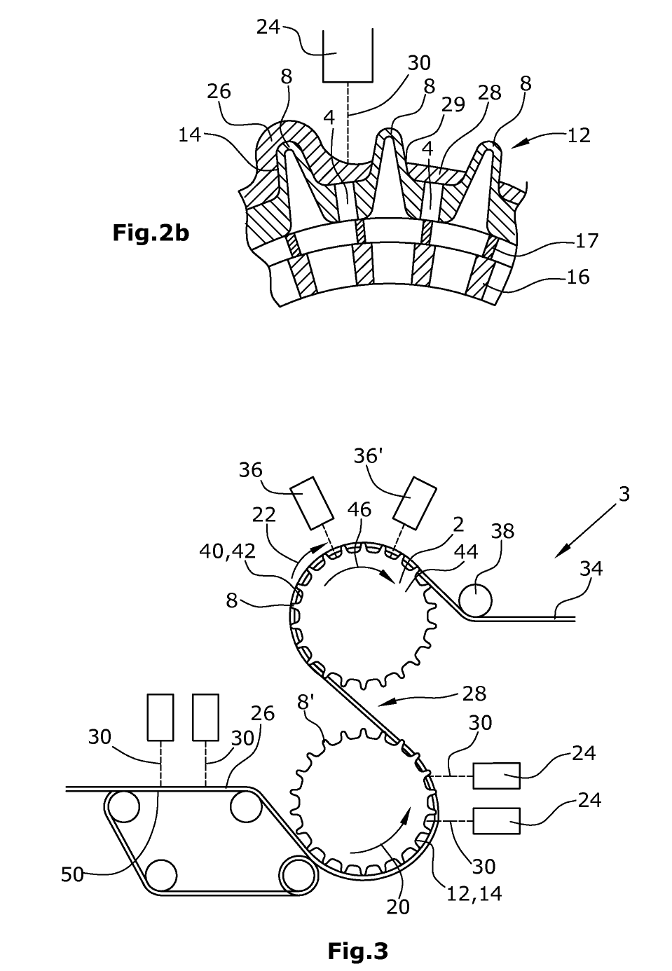

FIG. 2 a partial view of FIG. 1,

FIG. 2a a partial view showing a further exemplary embodiment,

FIG. 2b a partial view showing a further exemplary embodiment,

FIG. 3 a device for perforating a non-woven fabric, comprising a second carrier element,

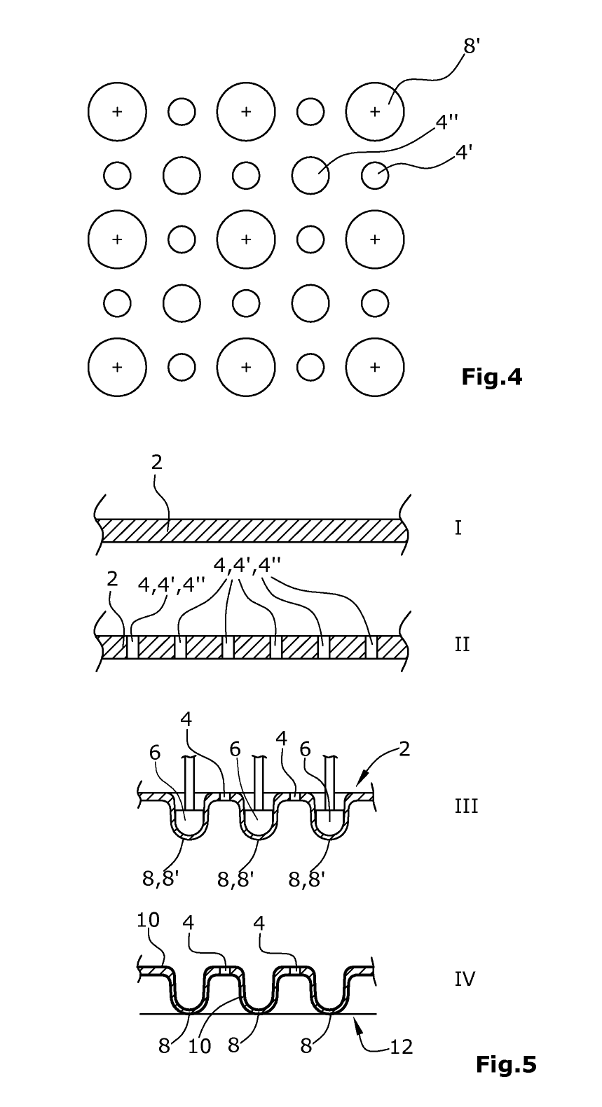

FIG. 4 a plan view of a carrier element,

FIG. 5 method steps of a method for producing a carrier element for a device for perforating a non-woven fabric.

FIG. 1 shows a device 1 for perforating a non-woven fabric 26, 28, 34 by means of hydrodynamic needling. Such a device 1 comprises at least one first carrier element 12. The carrier element 12 comprises a carrier surface 14, wherein the first carrier surface 14 comprises first elevations 8 and first perforations 4 as a drainage opening.

The carrier element 12 shown in FIG. 1 is the drum shell of a drum 16. On said carrier element 12, a non-woven fabric 26 can be placed. By rotating said drum 16 about the axis 18 in the rotational direction 20, the non-woven fabric 26 can be transported in the transport direction 22. Said elevations 8 and said perforations 4 are not shown in FIG. 1. These are shown in greater detail in the partial view of FIG. 2.

The first carrier element can be realized as a self-supporting drum. Alternatively, the drum can comprise a base drum 16 having the first carrier element 12 applied on it as an outer layer. This is shown in FIG. 2a.

As a further alternative, it can be provided that the drum comprises a base drum 16 having a support cloth 17 arranged on it, wherein the first carrier element 12 is arranged on this support cloth. This is shown in FIG. 2b.

The device 1 further comprises a first nozzle bar 24. Also further nozzle bars 24′ can be provided. Said first nozzle bar 24 comprises openings. From said openings, a liquid, preferably water, is issued with high pressure. This liquid 30 will impinge as a liquid jet onto the non-woven fabric 26 arranged on the carrier element 12.

By the high pressure of the liquid, the fibers of the non-woven fabric 26 which are arranged on the elevations 8 will be washed off from the elevations 8. In this manner, perforations will be generated in the non-woven fabric. The liquid 30 will then pass through the non-woven fabric, and through the perforations 4 of the first carrier element 12 which are used as drainage openings, into the interior of the drum. From there, the liquid will be evacuated and can again be supplied to the nozzle bar 24.

In FIG. 2, it is shown that the non-woven fabric 26 initially is arranged on the carrier surface 14 of carrier element 12. When the non-woven fabric 26 is subjected to the liquid 30, fibers arranged on the elevations 8 will be washed off from these. This can also be seen in FIG. 2. In the right-hand area of this Figure, the fibers have already been washed off from the elevations 8. Further, between the elevations 8, the non-woven fabric 28 provided with perforations 29 will be solidified by the liquid 30. In FIG. 2, this is evident from the fact that the non-woven fabric 28 which has already been subjected to the liquid 30 has a smaller thickness than the non-woven fabric 26 28 which has not yet been subjected to liquid.

The size and the shape of the elevations 8 of the first carrier element 12 are preferably selected in such a manner that, in hydrodynamic needling, a heavy non-woven fabric having a weight per unit area of at least 70 g/m² can be perforated by the elevations 8 such that perforations 29 are generated in the non-woven fabric that have an opening width of at least 5 mm. The first carrier element 12 preferably consists of a sheet-metal element and a coating, and the elevations can be formed in the sheet-metal element by deep drawing and are coated by the coating. This will be described in greater detail with reference to FIG. 5.

In accordance with a further exemplary embodiment, FIG. 3 shows a further device for perforating a non-woven fabric by means of hydrodynamic needling. Said device 3, like the device 1 from FIG. 1, comprises a first carrier element 12 which corresponds to the carrier element 12 of FIG. 1. Further, as in the device 1 from FIG. 1, a non-woven fabric 28 provided with perforations 29 is produced on the first carrier element 12 by subjecting it with a liquid 30.

The device according to FIG. 3 comprises a second carrier element 40 comprising a second carrier surface 42 having second elevations 8′ and second perforations 4′. The perforations 4′ are again used as a drain opening. The elevations 8′ of the second carrier element 40 have such a distance from each other and the non-woven fabric 28 provided with the perforations 29 can be positioned on the second carrier element 40 in such a manner that the elevations 8′ of the second carrier element 40 protrude into the perforations 29 of the non-woven fabric 28 arranged on the second carrier element 40.

Also the elevations 8′ of the second carrier element 40 preferably have the same shape as the elevations of the first carrier element 12. What is decisive, however, is the distance between the elevations 8′. This distance is preferably the same as the distance between the elevations 8 of the first carrier element 12. However, there also exist non-woven fabrics which, when detached from the first carrier element, will expand by 0.5 to 5% in the transport direction. In these non-woven fabrics, it is provided that the distance in the circumferential direction between the second elevations of the second carrier element is correspondingly by 0.5 to 5% larger than the distance in the circumferential direction of the first elevations of the first carrier element. The distance in the axis-parallel direction between the two elevations is equal to the distance in the axis-parallel direction between the first elevations.

The non-woven fabric 28 provided with perforations can be transported from the first carrier element 12 to the second carrier element 40 and be arranged in such a manner on the carrier element 40 formed as a drum that the elevations 8′ of the second carrier element 40 extend into the perforations 29 of the non-woven fabric 28. The second carrier element 40 is formed as a drum 44 and rotates in the transport direction and will transport the perforated non-woven fabric 28 in the transport direction 22.

Further, two second nozzle bars 36, 36′ are provided from which a highly pressurized liquid 30 will exit via the openings and impinge onto the non-woven fabric 28 which has already been provided with perforations.

In this manner, that part of the fibers of the non-woven fabric 28 which during the treatment with liquid 30 on the first carrier element 12 have not been washed off from the elevations 8, will during the treatment with the liquid 30 on the second carrier element 40 be washed from the second elevations 8′ of the second carrier element 40. Further, the elevations 8′ can have a larger size and, during the second treatment with the liquid on the second carrier element 40, larger perforations can be formed in the non-woven fabric than during the first treatment with liquid. Large perforations in the non-woven fabric can be realized only in that the non-woven fabric will be perforated both on the first and on the second carrier element, wherein the diameter of the second elevations is selected to be larger than the diameter of the first elevations.

Further, prior to being transported to the first carrier element 12, the non-woven fabric 26 will be pre-solidified by means of liquid 30 issuing from nozzle bars.

The shape and the size of the elevations 8′ of the second carrier element 40 can be selected in such a manner that the elevations 8′ of the second carrier element 40 can be caused to project into the perforations 29 of the non-woven fabric 28 which is to be placed on the second carrier element 40, the elevations 8′ preferably having a height corresponding to about half the diameter of the elevation; for instance, at a diameter of 7 mm, a height of 3.5 mm will be selected.

The elevations of the first and/or second carrier element 12, 40 can have a width and respectively a diameter in the range from 5 to 15 mm. The elevations 8, 8′ of the first and the second carrier element 12, 40 can have the shape of spikes. Further, they can have a conically tapering or frustoconical shape. The base of the elevations 8 and respectively 8′ can have a circular, semicircular, oval or polygonal cross-sectional shape. FIG. 4 shows a plan view of the second carrier element 40 of an exemplary embodiment. In this Figure, the elevations 8′ and the perforations 4′ and 4″ are illustrated. The perforations 4″ are larger than the perforations 4′. The elevation 8′ is surrounded by the perforations 4′. As evident from FIG. 4, the cross-sectional shape of elevations 8′ is circular.

In FIG. 3, it is further illustrated that the non-woven fabric 26 will first be transported, by its non-woven bottom side, on the band 50 and, on the non-woven top side, will be subjected to the liquid 30 and be pre-solidified. Then, the non-woven fabric 26 will be placed on the first carrier element 12 by its non-woven top side, and the non-woven bottom side will be subjected to the liquid 30. Subsequently, the non-woven fabric will be transported to the second carrier element 40 and be placed on the carrier element 40 by its the non-woven bottom side, and its non-woven top side will be subjected to the liquid 30. In this manner, perforations are generated by subjecting both sides of the non-woven fabric to a liquid. Thereby, the non-woven fabric can be provided with perforations having a more precise shape.

In FIG. 5, there is illustrated a method for producing a carrier element 12, 40 for a device 1, 3 for perforating a non-woven fabric by means of hydrodynamic needling.

First, in method step I, a sheet-metal element 2 is produced. In the subsequent method step II, perforations 4, 4′, 4″ will be formed in the sheet-metal element 2. The perforations 4, 4′, 4″ can all have the same size. However, also different sizes can be provided.

In method step III, the elevations 8 and respectively 8′ will be formed in the sheet-metal element 2 by deep drawing. In the process, a deep-drawing stamp 6 will be pressed into the sheet-metal piece, and the sheet-metal piece 2 will be drawn at this site. In this manner, the elevations 8 and respectively 8′ will be produced. Method step III can also be performed prior to, or simultaneously with, method step II. The diameters of the elevations 8, 8′ are equal to the deep-drawing stamp diameter plus twice the sheet-metal thickness of sheet-metal element 2. The height of the elevations 8, 8′ is preferably equal to the diameter of the elevations 8, 8′.

In a final step IV, the sheet-metal element 2 will be provided with a coating 10. In FIG. 5, it is shown that the coating 10 will be applied on the whole sheet-metal element 2. It can also be applied only partially, e.g. on the elevations 8, 8′.

Preferably, there is used a sheet-metal piece having a thickness in the range from 1 to 2 mm. Further, deep-drawing stamps having a diameter in the range from 3 to 10 mm are used. In case of a stamp having a diameter of 3 mm and a sheet-metal piece having a thickness of 1 mm, there are formed e.g. elevations having a diameter of 5 mm and a height of about 2.5 MM.

1-19. (canceled)

20. A method for producing a carrier element for a device for perforating a non-woven fabric by means of hydrodynamic needling, by
producing a sheet-metal element,
forming perforations in the sheet-metal element,
forming elevations in the sheet-metal element by means of deep drawing, and
coating the sheet-metal element provided with said perforations and elevations.

21. The method according to claim 20, wherein the elevations which are formed in the sheet-metal element respectively have such a size and shape that, in hydrodynamic needling, a heavy non-woven fabric having a weight per unit area of at least 70 g/m² to 260 g/m² can be perforated by the elevations such that perforations are generated in the non-woven fabric that have an opening width of at least 4 mm.

22. The method according to claim 21, wherein the sheet-metal element is made of a material having such a toughness that the elevations can be formed in the sheet-metal element by means of deep drawing, said material preferably being a metal.

23. The method according to claim 22, wherein the sheet-metal element is coated with a material having a higher toughness than the material of the sheet-metal element.

24. The method according to claim 20, wherein the sheet-metal element is coated with a metal, preferably nickel.

25. A device for perforating a non-woven fabric by means of hydrodynamic needling, comprising
a first carrier element having a first carrier surface, wherein the first carrier surface has first elevations and first perforations as drainage openings and wherein the non-woven fabric for processing can be placed on the first carrier surface,
at least one first nozzle bar comprising openings, wherein fibers of the non-woven fabric arranged on the first carrier surface which are arranged on the first elevations of the first carrier surface can be flushed down from the elevations by means of liquid emerging under high pressure from the openings of the first nozzle bar, such that perforations are created in the non-woven fabric,
wherein a second carrier element is provided, comprising a second carrier surface having second elevations and second perforations as drainage openings,
wherein, on the one hand, the elevations of the second carrier element have such a distance each other and, on the other hand, the non-woven fabric provided with the perforations can be positioned on the second carrier element in such a manner that the elevations of the second carrier element protrude into the perforations of the non-woven fabric arranged on the second carrier element,
wherein at least one second nozzle bar is provided and wherein the non-woven fabric can be subjected to a liquid emerging under high pressure from the openings of the second nozzle bar.

26. The device according to claim 25, wherein the non-woven fabric can be placed on the first carrier element by a non-woven-fabric top side and wherein the non-woven fabric on a non-woven-fabric bottom side can be subjected to the liquid emerging from the openings of the first nozzle bar, and wherein the non-woven fabric can be placed on the second carrier element by the non-woven-fabric bottom side and the non-woven fabric on the non-woven-fabric top side can be subjected to the liquid emerging from the openings of the second nozzle bar.

27. The device according to claim 25, wherein the shape and the size of the respective elevations of the second carrier element are selected in such a manner that the elevations of the second carrier element can be caused to project into the perforations of the non-woven fabric which is to be placed on the second carrier element, the elevations preferably having a height corresponding to at least half the diameter of the elevations.

28. The device according to claim 25, wherein the sizes and the shape of the elevations of the first and the second carrier element are selected in such a manner that, in hydrodynamic needling, a heavy non-woven fabric having a weight per unit area of at least 70 g/m² can be perforated by the elevations such that perforations are generated in the non-woven fabric that have an opening width of at least 4 mm.

29. A device for perforating a non-woven fabric by means of hydrodynamic needling, comprising
a first carrier element having a first carrier surface, wherein the first carrier surface has first elevations and first perforations as drainage openings and wherein the non-woven fabric for processing can be placed on the first carrier surface,
at least one first nozzle bar comprising openings, wherein fibers of the non-woven fabric arranged on the first carrier surface which are arranged on the first elevations of the first carrier surface can be flushed down from the elevations by means of liquid emerging under high pressure from the openings of the first nozzle bar, such that perforations are created in the non-woven fabric,
wherein the sizes and the shape of the elevations of the first carrier element are selected in such a manner that, in hydrodynamic needling, a heavy non-woven fabric having a weight per unit area of at least 70 g/m² can be perforated by the elevations such that perforations are generated in the non-woven fabric that have an opening width of at least 4 mm,
wherein the first carrier element consists of a sheet-metal element and a coating, and the elevations can be formed in the sheet-metal element by deep drawing and are coated by said coating.

30. The device according to claim 25, wherein the respective sheet metal element is made of a material having such a toughness that the elevations can be formed by means of deep drawing.

31. The device according to claim 25, wherein the respective coating consists of a material having a higher toughness than the material of the respective sheet-metal element.

32. The device according to claim 25, wherein the respective coating consists of metal, preferably nickel.

33. The device according to claim 25, wherein the elevations of the first and/or the second carrier element have a diameter of at least 4 mm and the shapes of the elevations are selected in such a manner that a heavy non-woven fabric having a weight per unit area of at least 70 g/m², preferably a weight per unit area in the range from 100 g/m² to 260 g/m², can be perforated.

34. A method for perforating a heavy non-woven fabric having a weight per unit area of at least 70 g/m², by
applying a non-woven fabric having a weight per unit area of at least 70 g/m² onto a first carrier surface of a first carrier element, the first carrier surface having first elevations and first perforations as drainage openings,
forming perforations in the non-woven fabric by a first treatment of the non-woven fabric on the first carrier surface by means of highly pressurized liquid, wherein at least a part of the fibers of the non-woven fabric which during the liquid treatment are placed on the elevations, are washed down from the elevations by means of said liquid so that perforations are generated in the non-woven fabric,
applying the non-woven fabric provided with said perforations onto a second carrier surface of a second carrier element, the second carrier surface having second elevations and second perforations as drainage openings, wherein, on the one hand, the second elevations have such a distance from each other and, on the other hand, the non-woven fabric provided with the perforations is positioned on the second carrier surface in such a manner that the elevations protrude into the perforations,
second treatment of the non-woven fabric on the second carrier surface by means of a highly pressurized liquid.

35. The method according to claim 34, wherein, in the second treatment with liquid, a part of the fibers of the non-woven fabric which in the first treatment with liquid have not been washed off from the first elevations, are washed from the second elevations.

36. The method according to claim 34, wherein the non-woven fabric arranged by a non-woven-fabric top side on the first carrier element is subjected to liquid from a non-woven-fabric bottom side and wherein the non-woven fabric provided with perforations and arranged on the second carrier element is subjected to liquid from a non-woven-fabric top side.

37. The method according to claim 34, wherein perforations having an opening width of at least 4 mm are generated in the non-woven fabric, said perforations having an opening width of at least 4 mm being generated in that the sizes and the shape of the elevations are selected to the effect that the fibers of the non-woven fabric which during the liquid treatment are placed on the elevations, are washed down from the elevations by means of said liquid.

38. The method according to claim 34, wherein a geotextile is produced.
